(19) United States
(12) Patent Application Publication
(10) Pub. No.: US 2018/0354220 A1
(43) Pub. Date: Dec. 13, 2018

(54) INTERNAL PASSAGE CONVEYOR CARRIAGE AND RELATED DEVICES

(71) Applicant: KHS USA, Inc., Sarasota, FL (US)

(72) Inventors: Donald Scott Peebles, Bradenton, FL (US); Roger Calabrese, Bradenton, FL (US); Oliver Watmough, Sarasota, FL (US)

(73) Assignee: KHS USA, Inc., Sarasota, FL (US)

(21) Appl. No.: 16/000,212

(22) Filed: Jun. 5, 2018

Related U.S. Application Data
(60) Provisional application No. 62/517,116, filed on Jun. 8, 2017.

(51) Int. Cl. B31B 70/00

(52) U.S. Cl. CPC B31B 70/008; B31B 2160/20; B31B 70/004; B31B 70/003

(57) ABSTRACT

A packaging machine has at least one carriage including a carriage body defining an internal passage dimensioned to receive a packaging sleeve, the internal passage extending along a passage axis with a passage sidewall extending therearound. A retention mechanism is configured to retain the packaging sleeve against the passage sidewall, one or more packaging subsystems are configured to perform an operation on the packaging sleeve, and a drive mechanism is configured to move the carriage to and from the packaging subsystem. Opposite ends of the internal passage along the passage axis can both be completely open from the passage axis to the passage sidewall. The retention mechanism can be configured to retain the packaging sleeve with vacuum. The packaging subsystem can include one or more of a sleeve infeed device, a sleeve spreader device, an indexing device, and a sealing device.

### CROSS-REFERENCE TO RELATED APPLICATION

This application claims the benefit of U.S. Provisional Patent Application Ser. No. 62/517,116, filed on Jun. 8, 2017, the contents of which are herein incorporated by reference in their entirety.

### FIELD OF THE INVENTION

The present invention relates to packaging machines, and more particularly, to packaging machines with carriages for carrying packaging sleeves to various subsystems for further operations.

### BACKGROUND OF THE INVENTION

On many packaging machine, and particularly horizontal pouching machines, it is typical to have a plurality of carriages holding packaging sleeves driven between packaging stations where various operations are performed. For example, a bottom seal might be applied at one station to form an open pouch, the pouch puckered and filled at another station, and finally de-puckered and top-sealed.

Frequently, the carriages for such machines employ pairs of clips to hold the pouches at discrete points on the sides. In some cases, such as can be seen in U.S. Pat. No. 6,237,841, a package may be deposited in a carriage with a retaining hole. While such carriages have been proven useful, further improvements are possible.

### SUMMARY OF THE INVENTION

In view of the foregoing, it is an object of the present invention to provide a packaging machine with a carriage having an internal passage surrounded by a passage sidewall against which a packaging sleeve is retained for one or more further operations. According to an embodiment of the present invention, a packaging machine has at least one carriage including a carriage body defining an internal passage dimensioned to receive a packaging sleeve, the internal passage extending along a passage axis with a passage sidewall extending therearound. A retention mechanism is configured to retain the packaging sleeve against the passage sidewall, one or more packaging subsystems are configured to perform an operation on the packaging sleeve, and a drive mechanism is configured to move the carriage to and from the packaging subsystem.

According to an aspect of the present invention, opposite ends of the internal passage along the passage axis are both completely open from the passage axis to the passage sidewall. According to a further aspect of the present invention, the retention mechanism is configured to retain the packaging sleeve with vacuum.

According to another aspect of the present invention, the packaging subsystem includes one or more of a sleeve infeed device, a sleeve spreader device, an indexing device, and a sealing device.

These and other objects, aspects and advantages of the present invention will be better appreciated in view of the drawings and following detailed description of preferred embodiments.

### BRIEF DESCRIPTION OF THE DRAWINGS

FIG. 1 is an elevational view of a packaging machine using one or more carriages, according to an embodiment of the present invention;

FIG. 2 is a perspective view of a representative one of the carriages of FIG. 1;

FIG. 3 is an exploded perspective view of a body of the carriage of FIG. 2;

FIG. 4 is a sectional view of the body of the carriage of FIG. 2, taken along line 4-4 of FIG. 5;

FIG. 5 is a sectional view of the body of the carriage of FIG. 2, taken along line 5-5 of FIG. 3;

FIG. 6 is a perspective view of a sleeve infeed device for use in connection with the packaging machine and carriages of FIG. 1;

FIG. 7 is an elevational view of the sleeve infeed device of FIG. 6;

FIG. 8 is a sectional view of the sleeve infeed device of FIG. 6, taken along line 8-8 of FIG. 7, showing a sleeve prior to effective size reduction;

FIG. 9 is a sectional view of the sleeve infeed device of FIG. 6, taken along line 9-9 of FIG. 7, showing a sleeve after effective size reduction;

FIG. 10 is a perspective view of a sleeve spreader device for use in connection with the packaging machine and carriages of FIG. 1;

FIG. 11 is an elevational view of the sleeve spreader device of FIG. 10, prior to insertion into a representative carriage body of FIG. 2;

FIG. 12 is an elevational view of the sleeve spreader device of FIG. 10, after insertion into a representative carriage body of FIG. 2;

FIG. 13 is a top view of the sleeve spreader device inserted into the carriage body, as in FIG. 12, and prior to a spreading operation;

FIG. 14 is a top view of the sleeve spreader device inserted into the carriage body, as in FIG. 12, and after a spreading operation;

FIG. 15 is a perspective view of indexing devices for use in connection with the packaging machine and carriages of FIG. 1;

FIG. 16 is a perspective view of sealing devices for use in connection with the packaging machine and carriages of FIG. 1;

FIG. 17 is a perspective view of a representative one of the sealing devices of FIG. 16, with sealing bars thereof in a retracted position;

FIG. 18 is another perspective view of the sealing device of FIG. 17;

FIG. 19 is the same perspective view of the sealing device as FIG. 18, with the sealing bars in an extended position;

FIG. 20 is a top view of the sealing device of FIG. 17;

FIG. 21 is a sectional view of the sealing device of FIG. 17, taken along line 21-21 of FIG. 20;

FIG. 22 is a top view of a bottom plate of the sealing device of FIG. 17, with internal passages shown in broken lines; and

FIGS. 23A and 23B are collectively an exploded perspective view of the sealing device of FIG. 17.

### DETAILED DESCRIPTION OF PREFERRED EMBODIMENTS

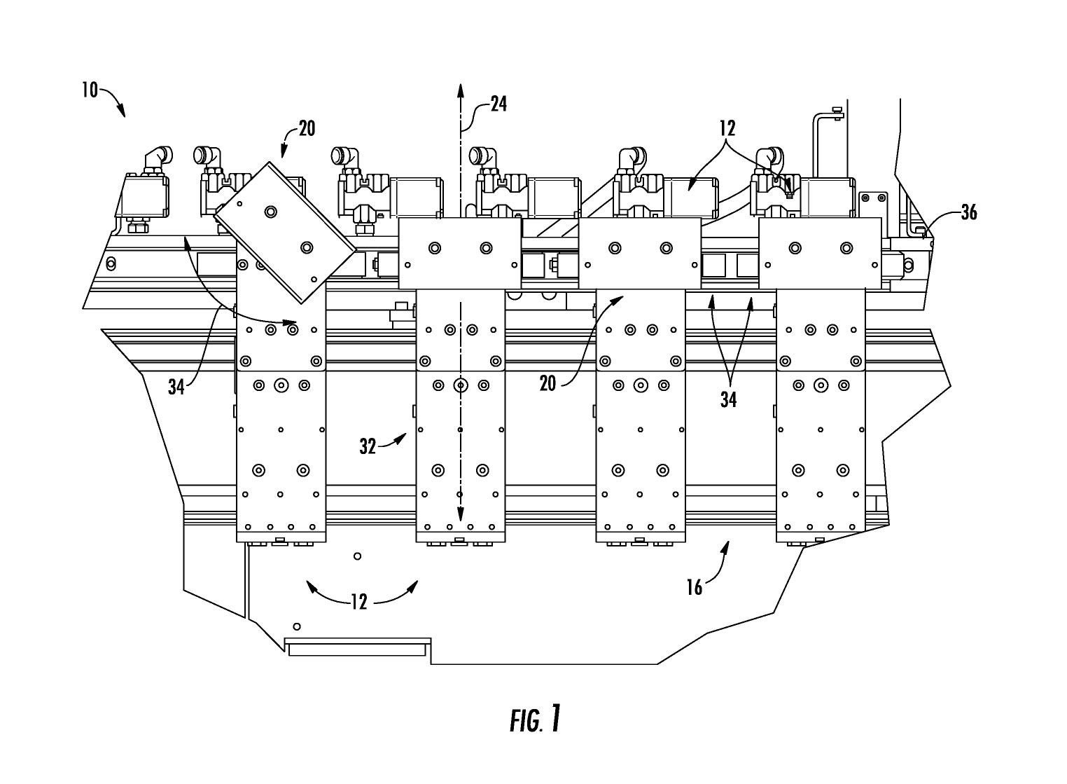

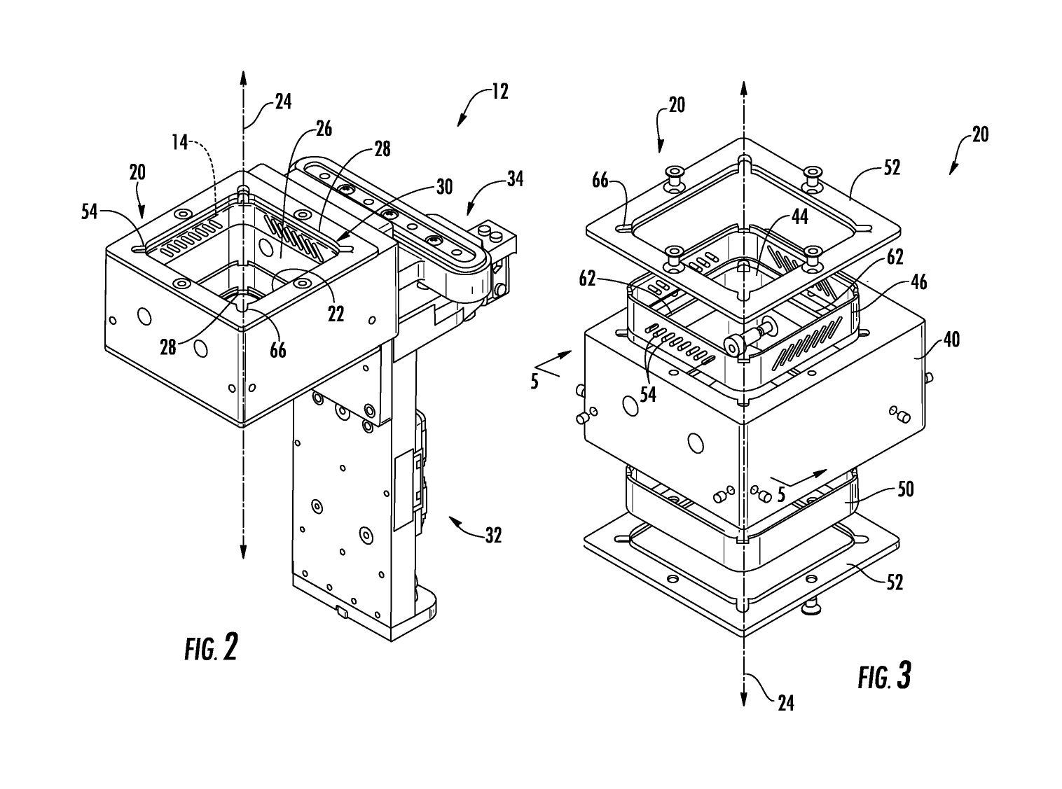

Referring to FIGS. 1 and 2, according to an embodiment of the present invention, a packaging machine 10 utilizes one or more carriages 12 configured to retain packaging sleeves 14. A drive mechanism 16 moves the carriages 12 to and from one or more packaging subsystems, to be described in greater detail below, where further operations are performed on the sleeves 14.

Each carriage 12 includes a carriage body 20 defining an internal passage 22 extending along a passage axis 24 and dimensioned to receive the packaging sleeve 14 (an upper edge thereof indicated in dashed lines on FIG. 2). A passage sidewall 26 bounds a perimeter of the internal passage 22 extending around the passage axis. A retention mechanism 30 is configured to retain the packaging sleeve 14 against the passage sidewall 26. With the sleeve 14 be retained against the sidewall 26, both ends 28 of the internal passage 22 can be completely open from the passage axis 24 to the sidewall 26.

Each carriage 12 further includes a mounting section 32 that holds the carriage body 20 and movably mounts the carriage 12 to the drive mechanism 16. In the depicted embodiment, the drive mechanism 16 is advantageously an electromagnetic drive mechanism configured to move each carriage independently. If desired, the carriage body 20 can be rotatably connected to the mounting section 32, allowing the orientation of the passage axis 24 to be rotated in the direction indicated by the arrow 34.

Preferably, the retention mechanism 30 is configured to retain the sleeve 14 using vacuum. In this case, the mounting section 32 advantageously further includes a vacuum connection 34 for receiving vacuum from a vacuum track 36 of the packaging machine 10 and supplying it to carriage body 20, as will be explained in greater detail below.

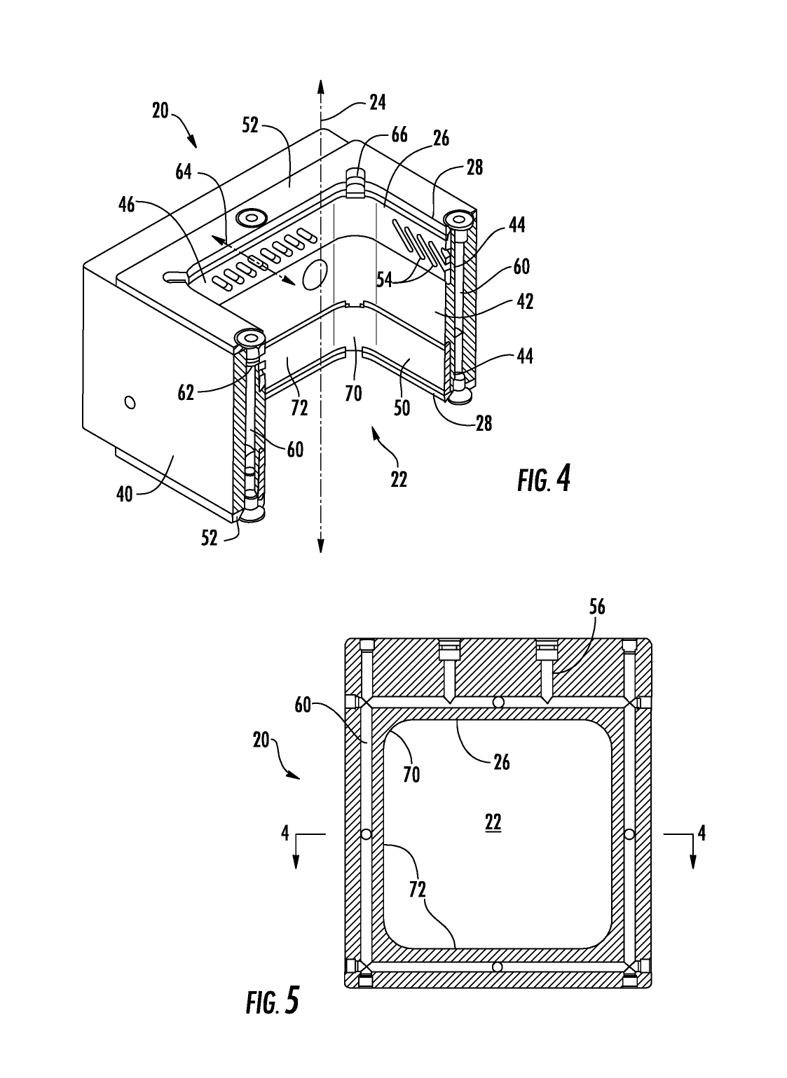

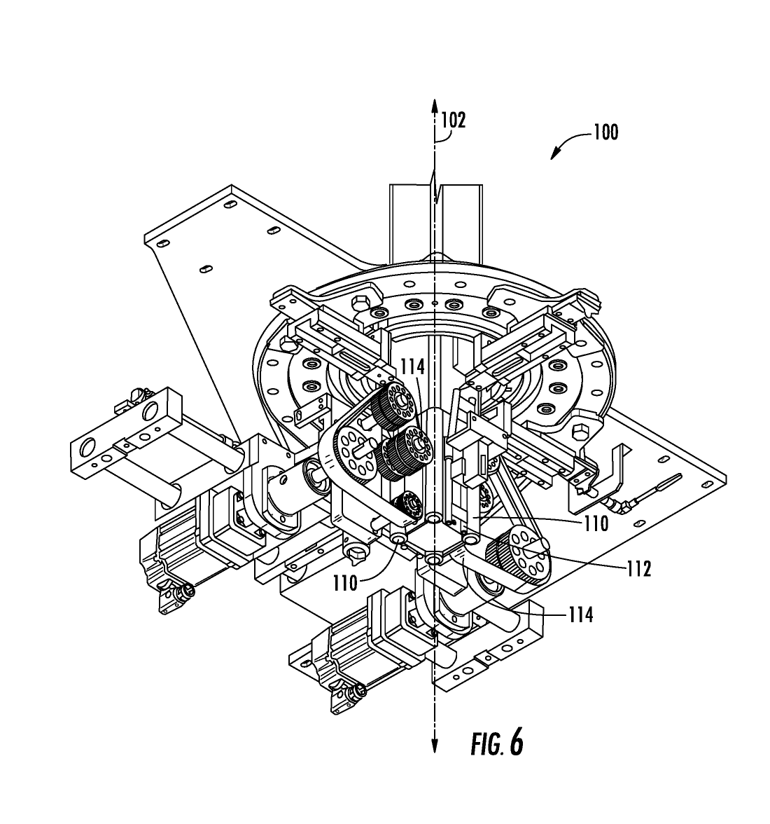

Referring to FIGS. 2-4, the carriage body 20 includes a central block 40 that connects to the mounting section 32. Along the internal passage 22, a central region 42 of the passage sidewall 26 is formed by an inner surface of the block 40. Adjacent the passage ends 28, inset areas 44 are formed in the block 40 in which first and second inserts 46, 50 are received. Flush with the central region 42, the inserts 46, 50 and central region 42 collectively define the passage sidewall 26. The inserts 46 are preferably formed of a resilient and heat resistant material (e.g., silicone) so as to offer a sealing surface for sealing operations performed on the sleeve within the internal passage 22 (as described below). Retention plates 52 are affixed to opposite ends of the central block 40 and hold the inserts 46, 50 in place.

The insert 46, which is preferably an upper insert with the passage axis 24 oriented vertically, includes a plurality of vacuum openings 54 via which vacuum supplied to the carriage body 20 is applied to retain the packaging sleeve 14 against the sidewall 26. Vacuum is supplied to from the mounting section via one or more vacuum channels 56, which includes a perimetric portion 60 formed within the block 40. Radial portions 62 connect the perimetric portion 60 with the inset area 44 behind the inset 46.

Advantageously, the vacuum openings 54 are arranged around a perimeter of the passage sidewall 26 inner surface near the uppermost opening 28, with each opening being elongated therealong. The long axis 64 of each opening is preferably oriented at an acute angle relative to the passage axis 24.

Indexing slots 66 extend into the internal passage 22 along the sidewall 26 from at least one end 28 down a predetermined distance along the passage axis 24. The indexing slots 66 are formed by aligned notches in the retention plate 52, insert 46 and block 40. In the depicted embodiment, the slots 66 are located at corners 70 of the internal passage 22.

The internal passage 22 is polygonal in cross section, with the corners 70 separating sides 72. The depicted passage is approximately square with radiused corners, although other geometries could readily be applied within the scope of the present invention. For example, circular passages could be used, or triangular passages or other polygonal passages could be used.

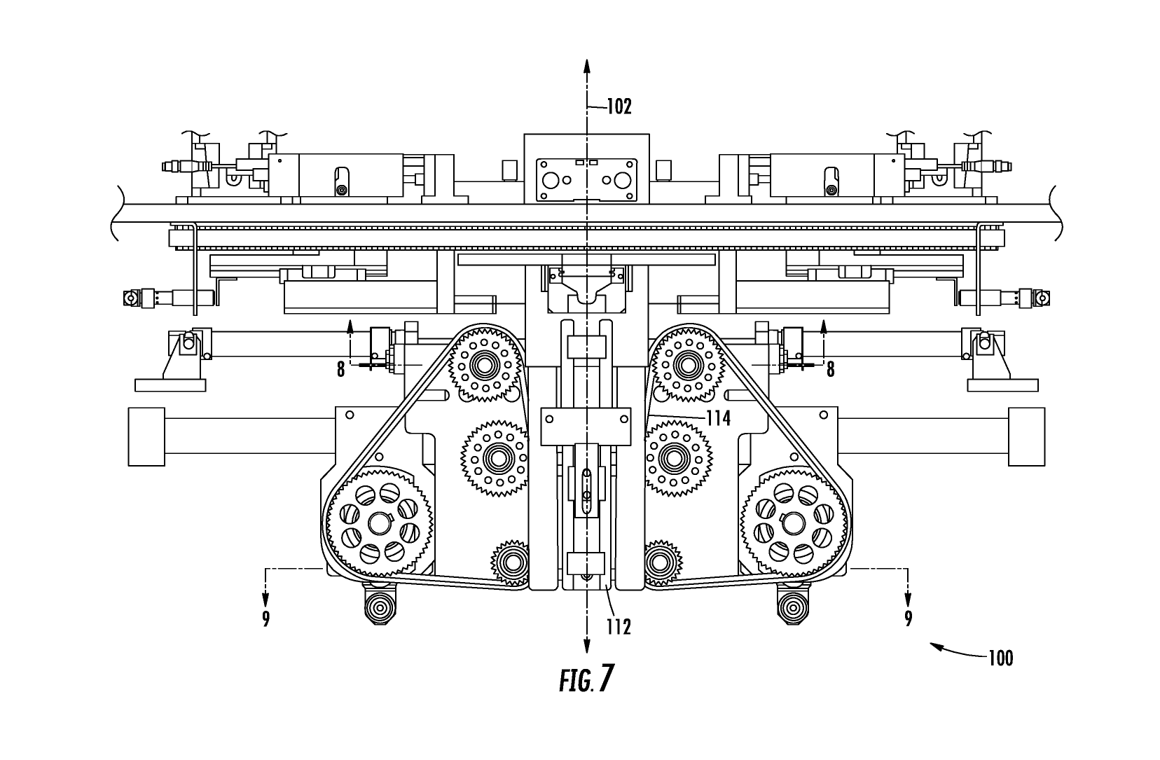

As discussed above, a packaging machine 10 utilizing the carriages can include one or more subsystems for performing operations involving the packaging sleeve. Referring to FIG. 6, according to an embodiment of the present invention, one of the subsystems includes a sleeve infeed device 100. The sleeve infeed device 100 extends along an infeed axis 102 with which the passage axis 24 aligns when a carriage 12 is positioned thereunder. For effective retention of the sleeve 14 against the passage sidewall 26, the dimensions of the sleeve 14 perpendicular to the passage/infeed axes 24, 102 will typically closely correspond to the dimensions of the internal passage 22. The sleeve infeed device 100 is configured to temporarily reduce an effective size of the sleeve 14 perpendicular to the infeed axis 102 to facilitate insertion into the internal passage 22.

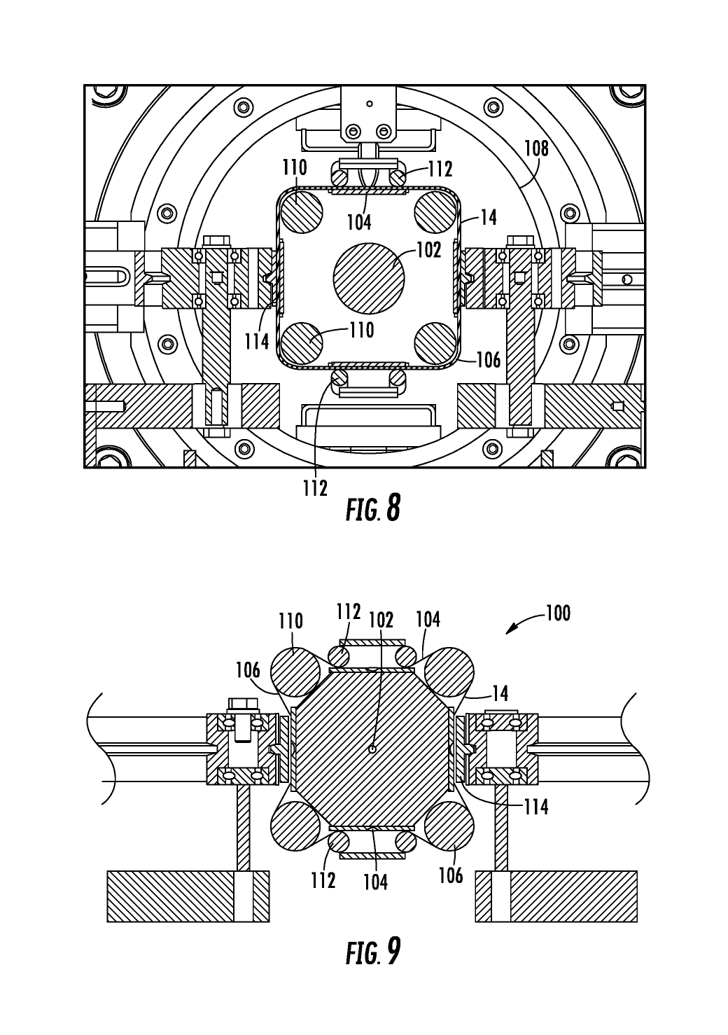

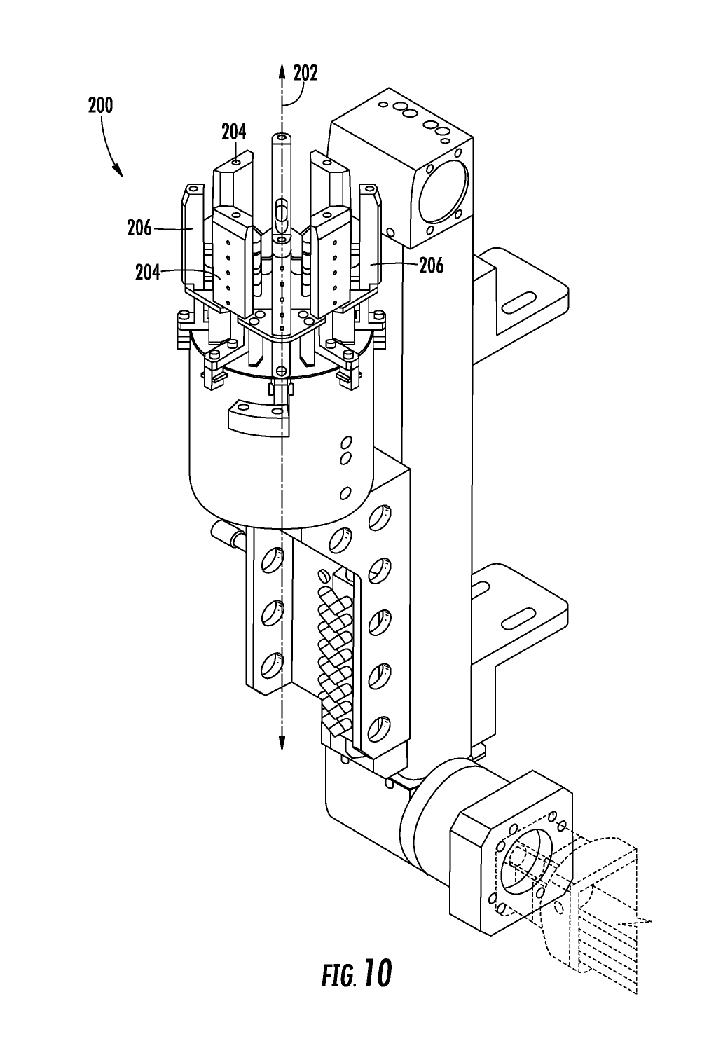

Referring also to FIGS. 7-9, the infeed device 100 generally urges sides 104 of the sleeve 14 inwardly of corners 106 (in the case of a non-polygonal sleeve, predetermined points along the perimeter of a sleeve could be urged inwardly of other, intervening points). In the depicted embodiment, the infeed device 100 includes corner posts 110 corresponding to the corners 106 of the sleeve 14 (and the corners 70 of the internal passage 22). The outer surfaces of the corner posts 110 are positioned closer to the infeed axis than inner surface of the corners 70 are to the passage axis 24; accordingly, when the sleeve sides 104 are urged inwardly, the corners 106 will also be urged inwardly to a lesser extent to clear the passage 22 corners 70.

Between the corner posts 110, restriction surfaces 112, 114 angle inwardly toward the infeed axis 102. Thus, as the sleeve 14 travels along the corner posts 110 in the direction of the infeed axis 102, the surfaces 112, 114 will urge the sides 104 inwardly of the corners. In the depicted embodiment with a four-sided sleeve 12, this results in a “clover” shape. This re-shaped sleeve 14 profile is able to enter the internal passage 22 without interference. Advantageously, one or more of the restriction surfaces 114 are also drive surfaces, such as belts, movable to impel the sleeve along the infeed axis 102 toward the internal passage 22.

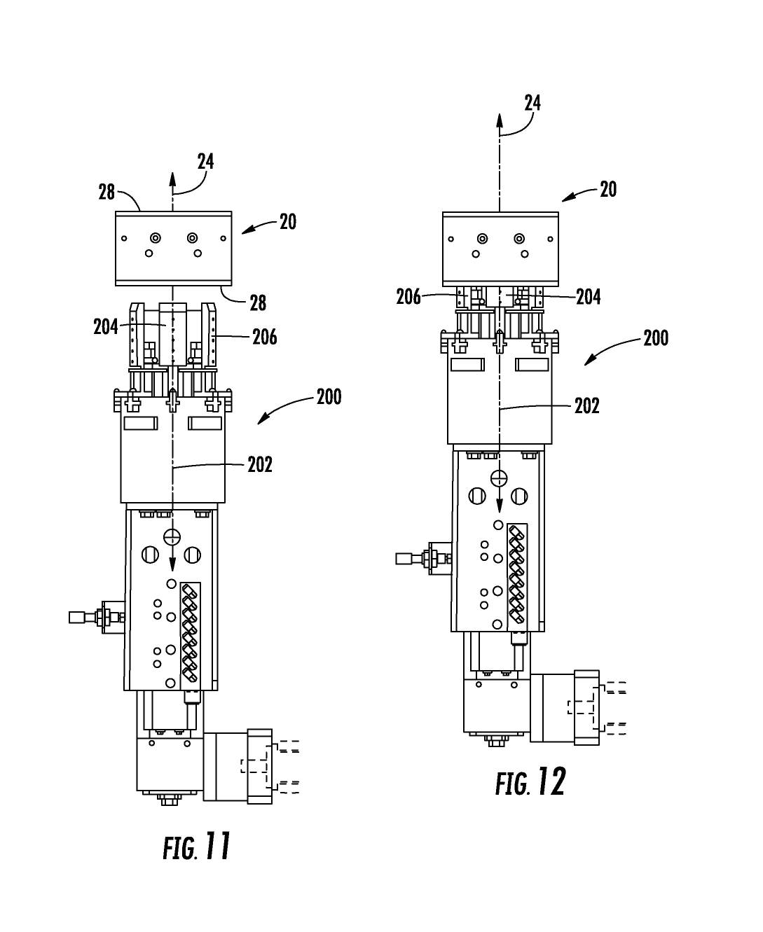

Having reduced the effective size of the sleeve 14 for infeed, it can be desirable to ensure the sleeve 14 is fully re-expanded after insertion to ensure secure retention against the passage sidewall 26. Referring to FIG. 10, according to a further embodiment of the present invention, another packaging subsystem is a sleeve spreader device 200. The spreader device 200 extends along a spreader axis 202 which, like the infeed axis 102, aligns with the passage axis 24 with a carriage aligned with the device 200. Advantageously, the spreader device 200 is positioned on the packaging machine 10 opposed the infeed device 100 such that the infeed and spreader axes 102, 202 are aligned, with the devices 100, 200 being located adjacent opposite ends 28 of the internal passage 22.

The spreader device 200 is configured urge the sleeve 14 into engagement with the passage sidewall 26 after being fed into the internal passage 22. The spreader device includes a plurality of spreader bars 204, 206 displaceable inwardly and outwardly relative to the spreader axis 202. In the depicted embodiment, the spreader bars 204, 206 include side spreader bars 204 and corner spreader bars 206 corresponding to the sides 72, 104 and corners 70, 106 of the internal passage 22 and sleeve 14. The number and configuration of spreader bars could readily be adapted based on the desired geometry of the internal passage and sleeve.

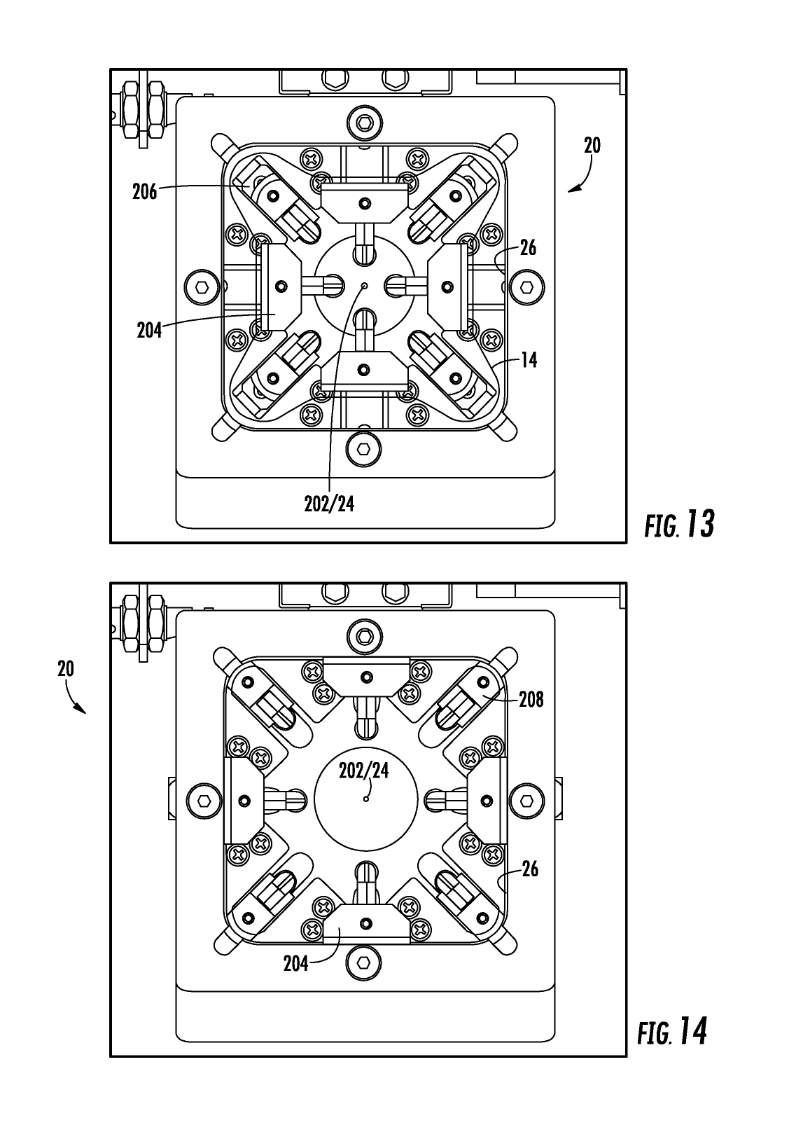

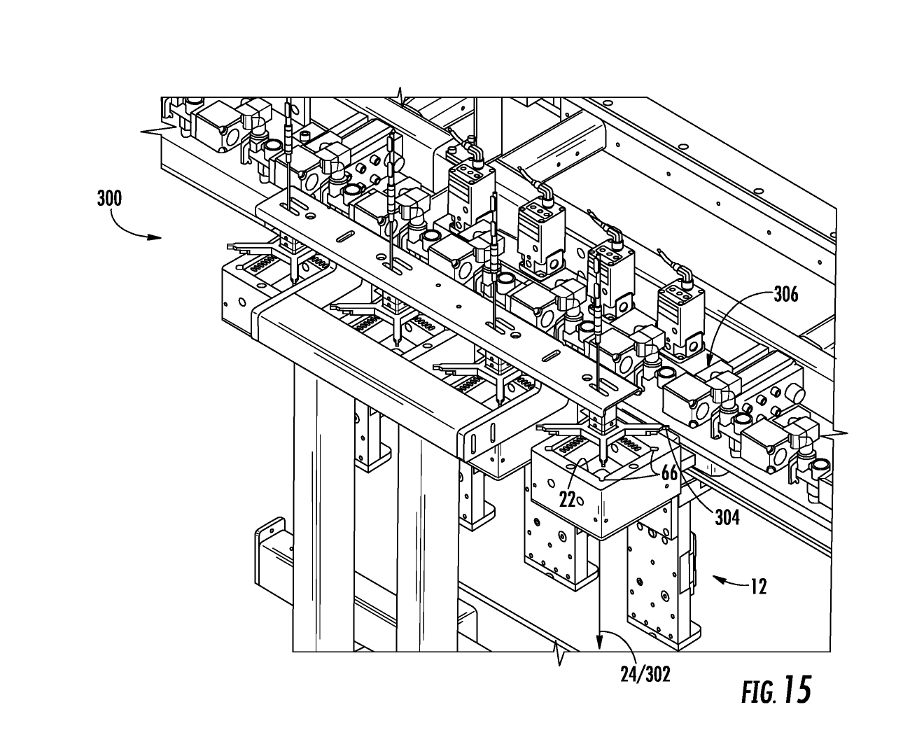

Referring also to FIGS. 13 and 14, the spreader bars 204, 206 are movable between inward positions (FIG. 13), fitting within the re-shaped sleeve 14, and outward positions (FIG. 14), urging the sleeve 14 into contact with the passage wall 26. Once the retention mechanism 30 engages the sleeve 14, the bars 204, 206 can be moved inwardly to disengage the sleeve 14. As seen in FIGS. 11 and 12, the entire spreader device 200 is also movable along the spreader axis 202, which moves the spreader bars 204, 206 into (FIG. 11) and out of (FIG. 12) an open end 28 of the internal passage 22.

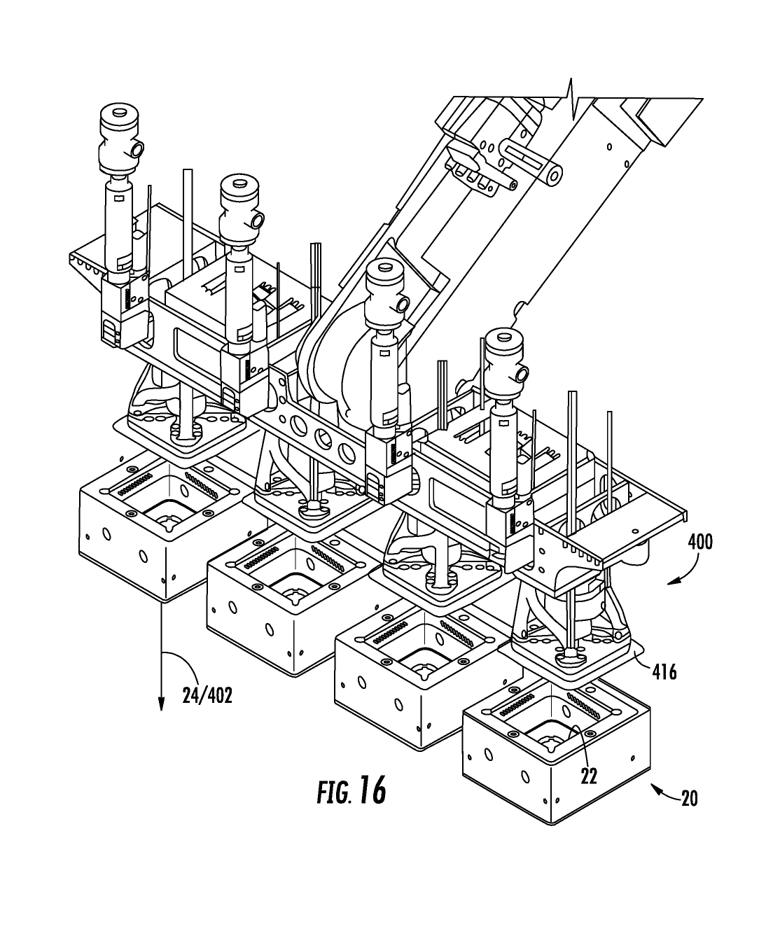

Referring to FIG. 15, according to an additional embodiment of the present invention another packaging subsystem includes an indexing device 300. With a carriage 12 positioned thereunder, the passage axis 24 aligns with an indexing axis 302 along which the indexing device 300 extends. The indexing device is configured to engage and a packaging sleeve 14 within the internal passage 22 and index the sleeve 14 to a predetermined position along the passage axis 24.

The indexing device 300 carries a plurality of indexing members 304 movable into and out of the indexing slots 66 of the carriage 12 along the indexing axis 302. The indexing members 304 will accordingly engage an edge of the sleeve 14 and urge the sleeve to an indexed position where the edge aligns with the bottom of the indexing slots.

At the indexing device 300, vacuum is supplied to the retention mechanism 30 via one or more vacuum valves 306. Preferably, the packaging machine 10 operates the corresponding vacuum valve 306 to reduce the level of vacuum supplied to the retention mechanism 30 during indexing operations, allowing the sleeve 14 to more readily move within the internal passage 22 under the impetus of the indexing members 30.

As will be appreciated from the depicted embodiment, the indexing device 300 can include a plurality of devices, allowing more than one carriage 12 and sleeve 14 to be indexed simultaneously. As in FIG. 15, four carriages 12 would be simultaneously advanced to align with four indexing devices 300, the four devices 300 would be actuated simultaneously, along with corresponding reductions in supplied vacuum. After indexing, vacuum would be restored to its normal level and the four carriages 12 would be advanced to the next subsystem for further operations, with four other carriages 12 taking their place.

With the sleeve 14 being open on one or both ends, another packaging subsystem advantageously includes a sealing device 400. The sealing device 400 extends along a sealing device axis 402 aligned with the passage axis 24, and is configured to move into and out of the internal passage 22 along the sealing device 402 for performing a sealing operation of the sleeve 14 therein.

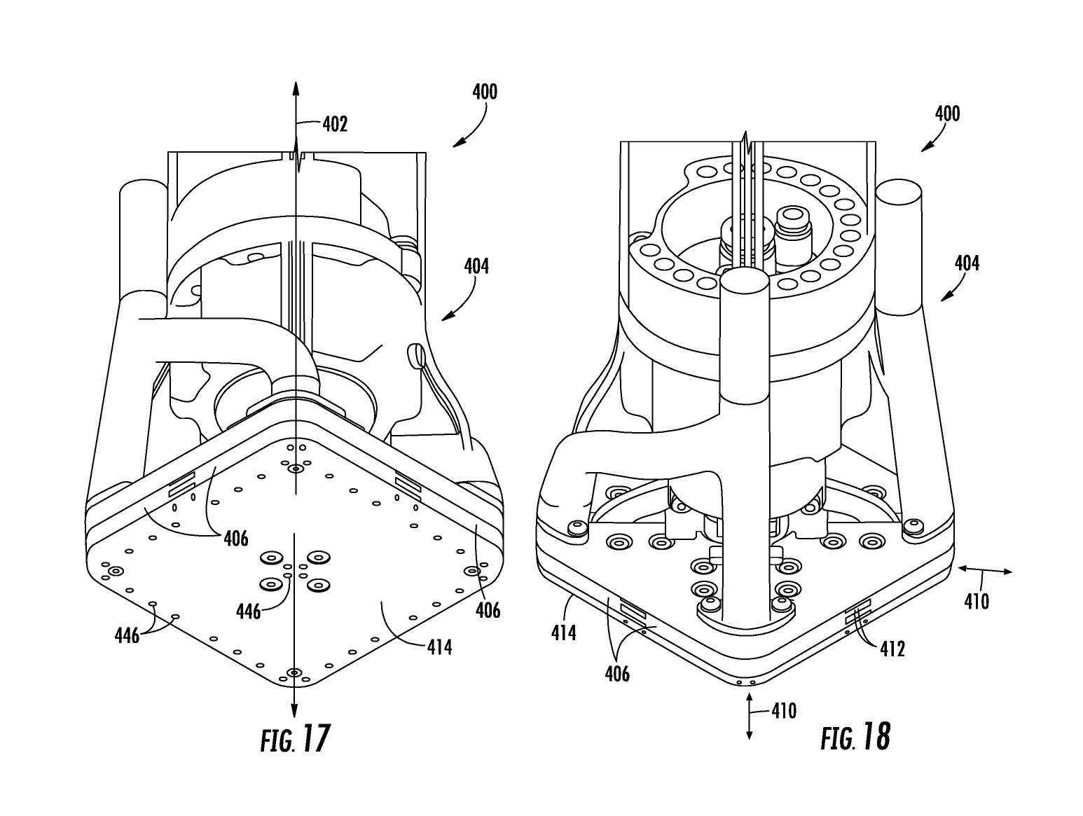

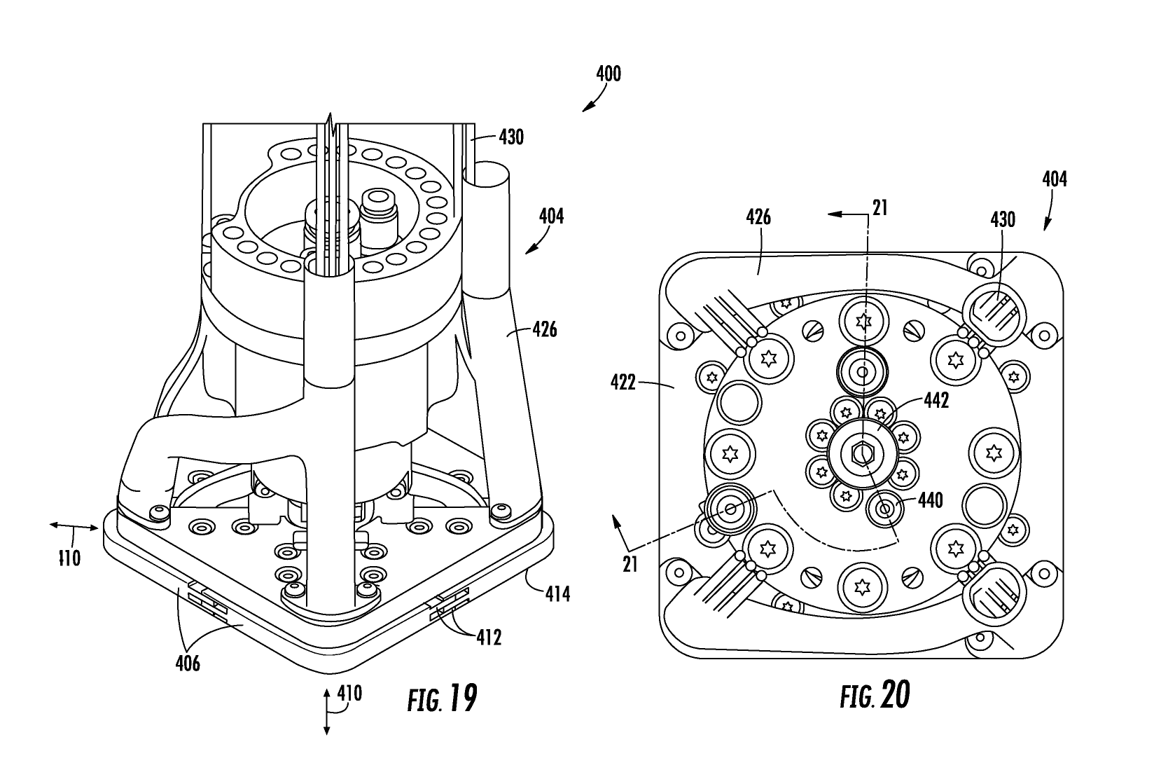

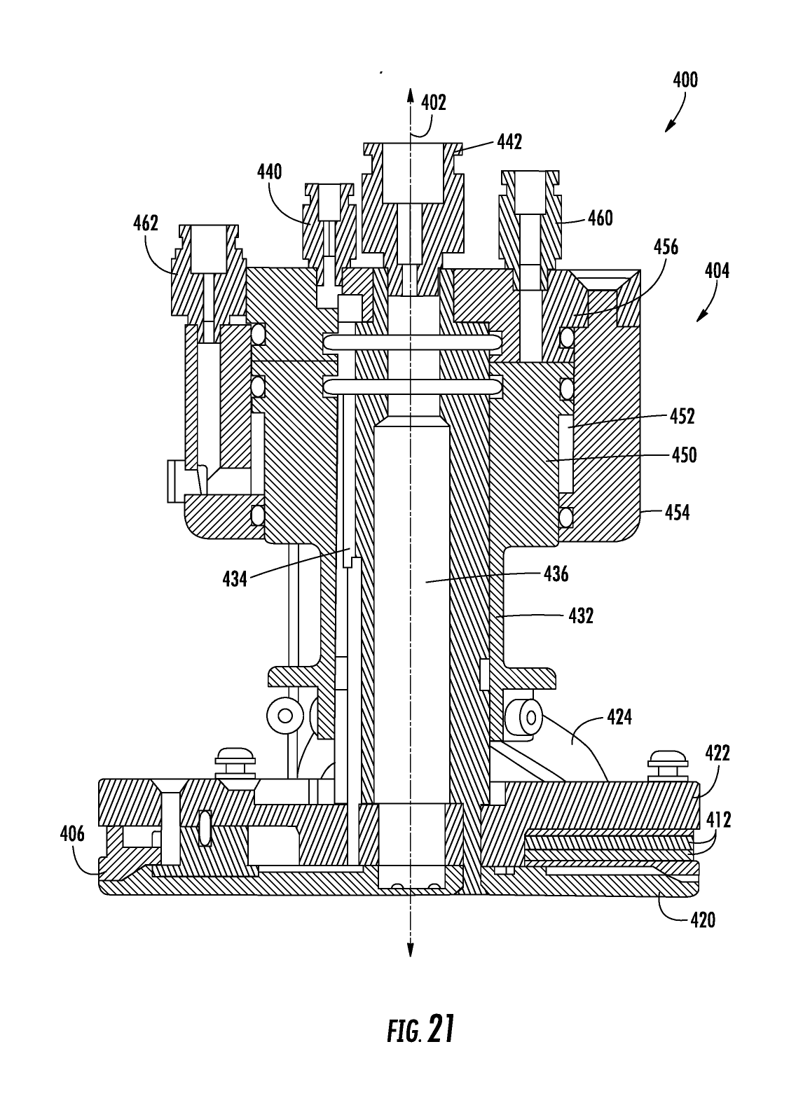

Referring also to FIGS. 17-19, the sealing device 400 includes a sealing device body 404 movable along the sealing device axis 402. A plurality of sealing bars 406 are carried by the body 404. Each sealing bar is slidable inwardly and outwardly relative to body 404 in a respective sealing direction 410, preferably perpendicular to the sealing device axis 402. Advantageously, the sealing bars 406 extend around a perimeter of the device body 404 so as to form a perimetric seal when applied to packaging seal. As described above, inserts 46, 50 of the internal passage 22 provide a resilient and heat resistant sealing surface therein.

Adjacent ends of the sealing bars 406 include intermeshing teeth 412. As the sealing bars 406 move outwardly in their respective sealing directions 410, the teeth 412 remain intermeshed, ensuring a complete seal.

The sealing bars 406 are preferably proximate to an axial end surface 414 of the sealing device body 404. The axial end surface 414 is configured to retain a packaging sheet portion 416 thereto. The sealing device 400 can accordingly pick up the packaging sheet portion 416, insert it into the sleeve 14 within the internal passage 22 and seal it perimetrically thereto.

In one application, a first set of sealing devices 400 can be used to connect sheets 416 to sleeves 14 to form base walls. The carriages 12 can then move the sleeves 14 to another packaging subsystem for filling with product, and onto a second set of sealing devices 400 where additional sheets 416 are connected to the sleeves 14 to form lids. If desired, the resultant completed packages can be discharged simply by removing applied vacuum and allowing the packages to exit the lower open ends 28 of the internal passages 22.

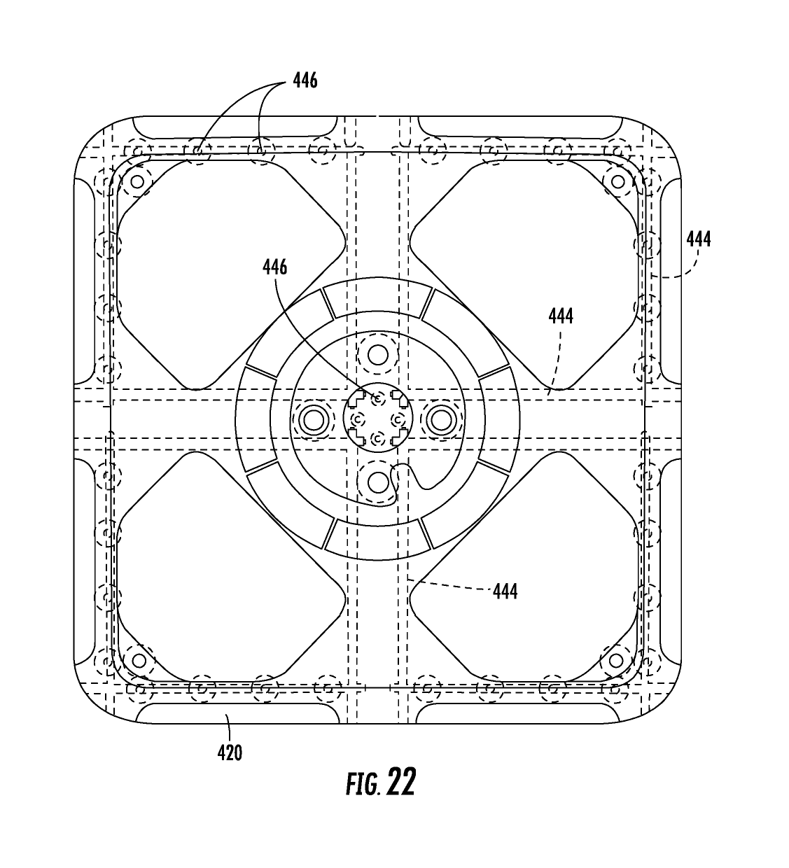

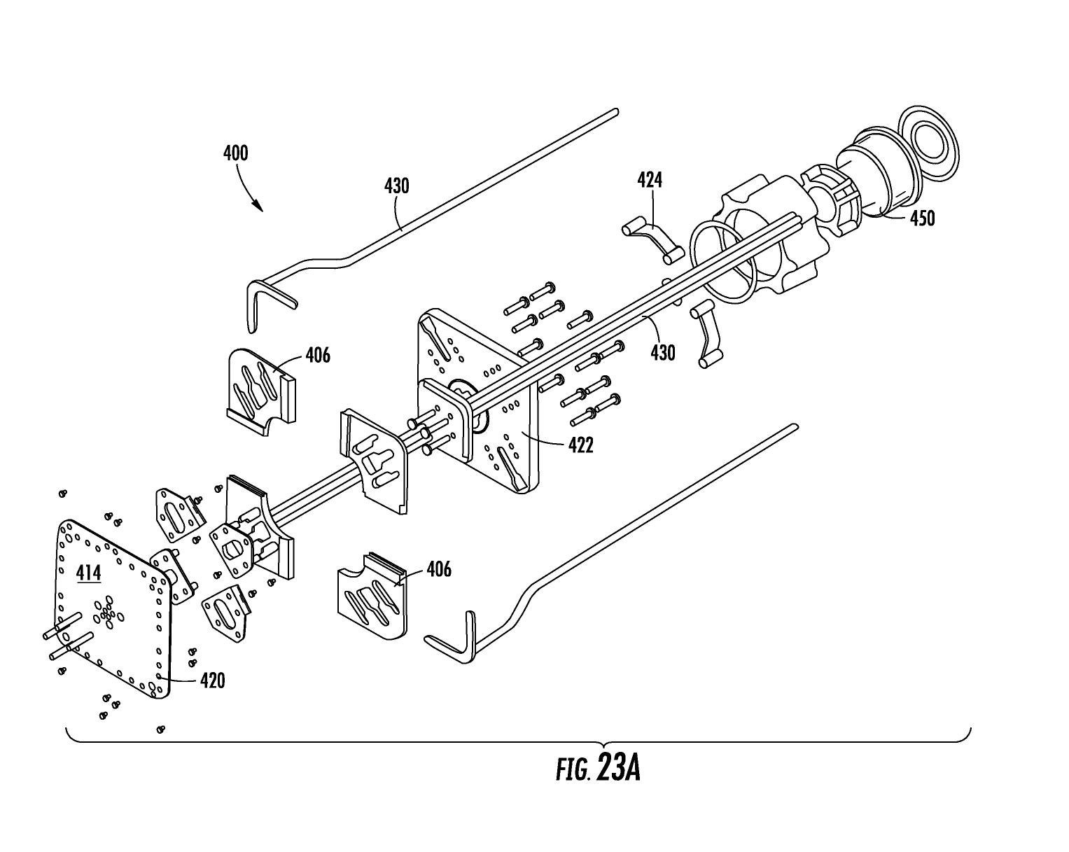

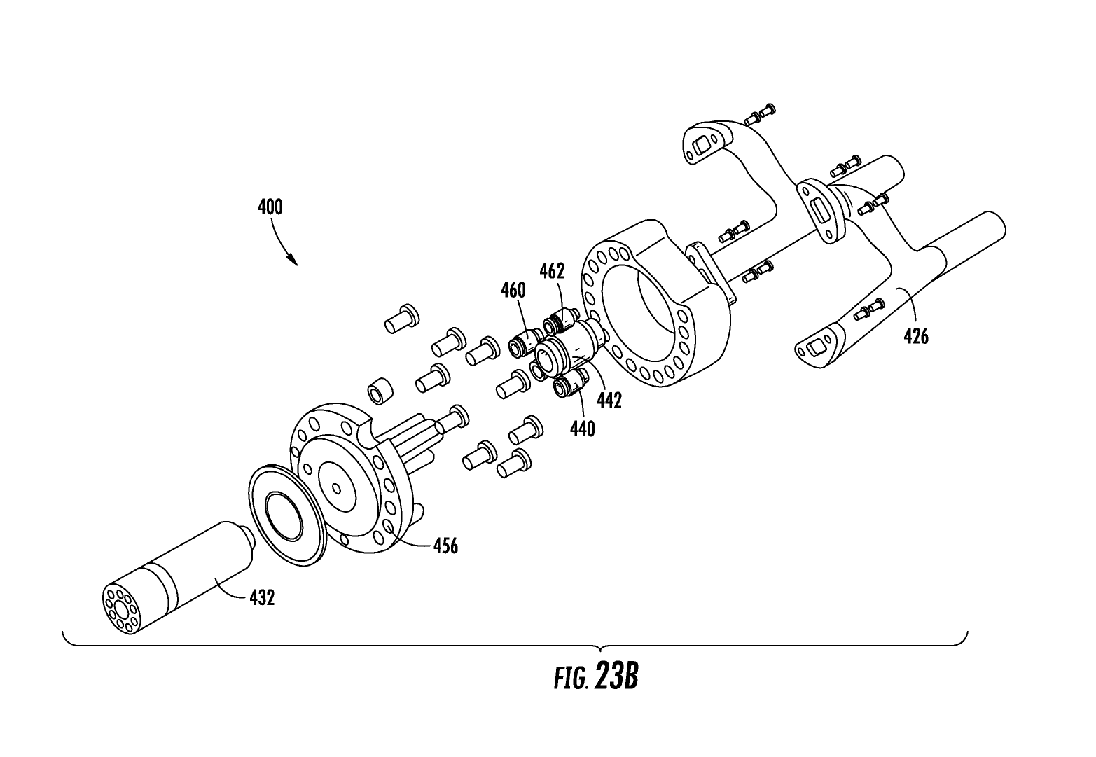

Referring also to FIGS. 20-23B, the sealing device body 404 includes first and second base plates 420, 422 between which the sealing bars 406 are slidably sandwiched, the first base plate 420 forming the axial end surface 414. Linkage arms 424 extending through the second base plate 422 are pivotably connected to the sealing bars 406. Cable guides 426 extend away from the second base plate 422 through which power cables 430 for applying heat to the sealing bars 406 are routed.

A central shaft 432 connects to the first and second base plates 420, 422 through which air passages 434, 436 are routed to supply cooling and vacuum/blow-off air, respectively. Respective air supply ports 440, 442 connect to the air passages 434, 436. The cooling air helps prevent overheating of the first base plate 420 and consequent undesirable melting and/or deformation of the sheets 416 in contact with the axial end surface 414. The cooling air flows laterally between the first and second base plates 420, 422, exiting the sealing device body 404 around the sealing bars 406.

Vacuum or blow-off air supplied via the port 442 and passage 436 is routed through internal channels 444 in the first base plate 420 to a plurality of air openings 446 on the axial end surface 414. The openings 446 preferably include central openings and peripheral openings, which are arranged around a perimeter of the axial end surface 414. With vacuum supplied, the sealing device 400 is operable to pick up and retain a packaging sheet portion 416. Positive blow off air pressure is supplied to ensure disengagement of the packaging sheet portion 416 to allow removal of the sealing device 400 without dislodging sleeve 14 attached to the sheet portion 416.

A sealing bar operating piston 450 slidably surrounds the central shaft 432 and is pivotably connected to the linkage arms 424 opposite the sealing bars 406. A pneumatic operating chamber 452 is formed between the piston 450 and surrounding collar 454. The collar 454 is fixed to the central shaft 432 by upper plate 456, such that the operating piston 450 is slidable between the collar 454 and shaft 432. Air (or other fluid) applied via a first operating port 460 extends the piston 450 and, consequently, the sealing bars 406 via the linkages 424. Air applied via a second operating port 462 retracts the piston and sealing bars 406.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and the claims appended hereto.

What is claimed is:

1. A packaging machine comprising:
at least one carriage including:
a carriage body defining an internal passage dimensioned to receive a packaging sleeve, the internal passage extending along a passage axis with a passage sidewall extending around the passage axis; and
a retention mechanism configured to retain the packaging sleeve against the passage sidewall;
at least one packaging subsystem configured to perform an operation on the packaging sleeve within the internal passage; and
a drive mechanism configured to move the carriage to and from the packaging subsystem.

2. The packaging machine of claim 1, wherein opposite ends of the internal passage along the passage axis are both completely open from the passage axis to the passage sidewall.

3. The packaging machine of claim 1, wherein the retention mechanism is configured to retain the packaging sleeve with vacuum, the retention mechanism including at least one vacuum opening extending through the passage sidewall, at least one vacuum channel being defined through the carriage body to the at least one vacuum opening.

4. The packaging machine of claim 3, wherein the at least one vacuum opening includes a plurality of vacuum openings arranged around a perimeter of the passage sidewall.

5. The packaging machine of claim 4, wherein the vacuum channel includes a perimetric portion extending through the carriage body outwardly of the plurality of vacuum openings.

6. The packaging machine of claim 4, wherein the passage axis is oriented vertically and the plurality of vacuum openings are arranged around the perimeter of the passage sidewall adjacent to an upper opening of the internal passage.

7. The packaging machine of claim 4, wherein the plurality of vacuum openings are elongated along an inner surface of the passage sidewall, a long axis of each of the vacuum openings being oriented at an acute angle relative to the passage axis.

8. The packaging machine of claim 4, wherein, across the passage axis, the internal passage is polygonal in cross section, having at least three sides separated by at least three corners.

9. The packaging machine of claim 8, wherein each of the corners is radiused.

10. The packaging machine of claim 8, wherein the internal passage has four sides separated by four corners.

11. The packaging machine of claim 1, wherein the at least one packaging subsystem includes a sleeve infeed device, the sleeve infeed device extending along an infeed axis aligned with the passage axis when the carriage is aligned with the sleeve infeed device, the sleeve infeed device being configured to temporarily reduce an effective size of the sleeve perpendicular to the infeed axis to facilitate insertion of the sleeve into the internal passage.

12. The packaging machine of claim 11, wherein, across the passage axis, the internal passage is polygonal in cross section, having at least three sides separated by at least three corners; and
wherein the sleeve infeed device is configured to urge corresponding sides of the sleeve inwardly of corresponding corners toward the infeed axis.

13. The packaging machine of claim 12, wherein the sleeve infeed device includes at least three corner posts corresponding to the at least three corners and arranged inwardly thereof, the sleeve infeed device being configured to feed the sleeve toward the internal passage outside of the corner posts.

14. The packaging machine of claim 13, wherein outer surfaces of each of the corner posts are closer to the infeed axis than inner surfaces of each of the corners are to the passage axis.

15. The packaging machine of claim 13, wherein the sleeve infeed device further includes restriction surfaces between the corner posts, each of the restriction surfaces angling inwardly toward the infeed axis the sleeve infeed device being configured to feed the sleeve toward the internal passage inside of the restriction surfaces.

16. The packaging machine of claim 15, wherein at least one of the restriction surfaces is formed by a drive surface, the drive surface movable to impel the sleeve along the infeed axis toward the internal passage.

17. The packaging machine of claim 16, wherein the internal passage has four sides separated by four corners, and the sleeve infeed device has four corner posts and four restriction surfaces and an opposed pair of the four restriction surfaces are formed by drive surfaces.

18. The packaging machine of claim 11, wherein another packaging subsystem includes a sleeve spreader device, the sleeve spreader device extending along an spreader axis aligned with the passage axis when the carriage is aligned with the sleeve spreader device, the sleeve spreader device configured to urge a sleeve fed into the internal passage by the sleeve infeed device into engagement with the passage sidewall.

19. The packaging machine of claim 18, wherein the sleeve spreader device includes at least one spreader bar displaceable inwardly and outwardly relative to the spreader axis.

20. The packaging machine of claim 19, wherein the sleeve spreader device is movable along the spreader axis so as to move the spreader bar into and out of the internal passage.

21. The packaging machine of claim 20, wherein opposite ends of the internal passage along the passage axis are both open; and
wherein the spreader axis is aligned with the infeed axis such that the sleeve infeed device and the sleeve spreader device are, respectively, adjacent the opposite ends of the internal passage with the carriage aligned therebetween.

22. The packaging machine of claim 19, wherein, across the passage axis, the internal passage is polygonal in cross section, having at least three sides separated by at least three corners; and
wherein the at least one spreader bar includes respective spreader bars corresponding to each of the sides and corners.

23. The packaging machine of claim 22, wherein the internal passage has four sides separated by four corners, and the respective spreader bars include four spreader bars for the side and four spreader bars for the corners.

24. The packaging machine of claim 1, wherein the at least one packaging subsystem includes an indexing device extending along an indexing axis aligned with the passage axis when the carriage is aligned with the indexing device, the indexing device configured to engage and index the packaging sleeve within the internal passage along the passage axis.

25. The packaging machine of claim 24, wherein the carriage body defines at least one indexing slot extending into the internal passage from an open end thereof to a predetermined distance along the passage axis; and
wherein the indexing device includes at least one indexing member movable into and out of the indexing slot.

26. The packaging machine of claim 25, wherein, across the passage axis, the internal passage is polygonal in cross section, having at least three sides separated by at least three corners; and
wherein the at least one indexing slot includes at least three indexing slots and the at least one indexing member includes at least three indexing members movable into and out of respective ones of the indexing slots.

27. The packaging machine of claim 26, wherein the at least three indexing slots are located at respective corners of the internal passage.

28. The packaging machine of claim 25, wherein the retention mechanism is configured to retain the packaging sleeve with vacuum, and the at least one indexing member is configured to move into the indexing slot when vacuum supplied to the retention mechanism is reduced.

29. The packaging machine of claim 1, wherein the at least one packaging subsystem includes a sealing device extending along an sealing device axis aligned with the passage axis when the carriage is aligned with the sealing device, the indexing device configured to move into and out of the internal passage along the sealing device axis and perform at least one sealing operation on the packing sleeve when located therein.

30. The packaging machine of claim 29, wherein the sealing device includes a sealing device body movably along the sealing device axis and at least one sealing bar carried thereon and movable inwardly and outwardly in a sealing direction perpendicular to the sealing device axis.

31. The packaging machine of claim 30, wherein a plurality of adjacent sealing bars are carried on the sealing device, the plurality of adjacent sealing bars being movable in a plurality of sealing directions so as to form a perimetric seal applied to the packaging sleeve along all a perimeter of a portion of the passage wall.

32. The packaging machine of claim 31, wherein adjacent ends of the plurality of sealing bars include intermeshing teeth configured so as to remain intermeshed when all of the sealing bars are moved outwardly in the sealing direction.

33. The packaging machine of claim 30, wherein an axial end surface of the sealing device body is further configured to retain a packaging sheet portion for insertion into the packaging sleeve and sealing thereto via the at least one sealing bar.

34. The packaging machine of claim 33, wherein the at least one sealing bar is adjacent to the axial end surface.

35. The packaging machine of claim 33, wherein the sealing device body defines at least one air passage extending therethrough and communicating between at least one air opening on the axial end surface and at least one air supply port, vacuum supplied to the air opening via the air supply port being effective to retain the packaging sheet portion on the axial end surface.

36. The packaging machine of claim 35, wherein positive air pressure selectively supplied via the air passage and air opening instead of vacuum is effective to detach the packaging sheet portion from the axial end surface.
